(19) United States
(12) Patent Application Publication
(10) Pub. No.: US 2007/0023291 A1
(43) Pub. Date: Feb. 1, 2007

(54) Metal Trap

(76) Inventor: Sai Bhavaraju, Salt Lake City, UT (US)

Correspondence Address: CERAMATEC, INC., 2425 SOUTH 900 WEST, SALT LAKE CITY, UT, 84119, US

(21) Appl. No.: 11/457,753

(22) Filed: Jul. 14, 2006

Related U.S. Application Data
(60) Provisional application No. 60/700,024, filed on Jul. 15, 2005.

(51) Int. Cl. B01D 61/46

(52) U.S. Cl. 204/630

(57) ABSTRACT

Disclosed are embodiment of systems, methods, and apparatus for decreasing the concentration of at least one ionic or molecular species comprising a metal in a solution. In one illustrative embodiment, an electrochemical device is provided that includes first and second electrodes coupled with one another. A metal trap is provided, which is configured to decrease the concentration of at least one ionic or molecular species comprising a metal, the ionic or molecular species having been generated by the electrochemical device in a solution proximate at least one of the electrodes. In some embodiments, the electrochemical device may be incorporated into a fluid delivery device.

### RELATED APPLICATIONS

This application claims the benefit under 35 U.S.C. § 119(e) of U.S. Provisional Patent Application No. 60/700,024, filed Jul. 15, 2005, and titled “Electro-Osmotic Fluid Delivery Device Containing a Metal or Metal Chloride Trap,” which is incorporated herein by specific reference.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a diagram of an embodiment of a metal chloride trap placed in a metal electrode chamber of an anionic electrokinetic fluid delivery device.

FIG. 2 is a diagram of an embodiment of a metal chloride trap placed in a silver chloride chamber of an anionic electrokinetic fluid delivery device.

FIG. 3 is a diagram of an embodiment of a metal chloride trap placed in a metal electrode chamber of a cationic electrokinetic fluid delivery device.

FIG. 4 is a diagram of an embodiment of a power source including a metal trap placed around an active metal electrode.

### DETAILED DESCRIPTION OF PREFERRED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments.

Disclosed are embodiments of systems, methods, and apparatus for decreasing the concentration of at least one ionic or molecular species comprising a metal, which has been generated by an electrochemical device in a solution. In some embodiments, unwanted osmosis contribution in the operation of an electrochemical engine, such as an electroosmotic engine, associated with a fluid delivery device may be prevented. This may be used, for example, to improve device start-up and shut-off times. Some embodiments may also operate to prevent exposure of metal ions to portions of the human body in, for example, an implantable device, such as an implantable fluid delivery device or implantable power source. This may be useful from, for example, toxicology, tissue response, encapsulation, and protein-interaction perspectives in some specific implant applications.

Examples of fluid delivery device components, some of which may be used in connection with embodiments of the systems, devices, and methods disclosed herein, can be found in U.S. Pat. No. 5,744,014 titled “Storage Stable Electrolytic Gas Generator for Fluid Dispensing Applications. ” U.S. Pat. No. 5,707,499 titled “Storage-stable, Fluid Dispensing Device Using a Hydrogen Gas Generator,” and U.S. Patent Application Publication No. 2003/205582 titled “Fluid Delivery Device Having an Electrochemical Pump with an Anionic Exchange Membrane and Associated Method.” Each of the foregoing reference are hereby incorporated by reference in their entireties.

Whereas many of the embodiments described herein are based on a Zn/AgCl system, it should be understood that the general principles set forth herein may be applicable to numerous other electrode systems, such as those described in the aforementioned incorporated references. It should also be understood that the principles set forth herein are applicable to both anionic electrokinetic (“ANEK”) and cationic electrokinetic (“CATEK”) systems, along with other systems, such as implantable power sources. Further details about such systems are provided below.

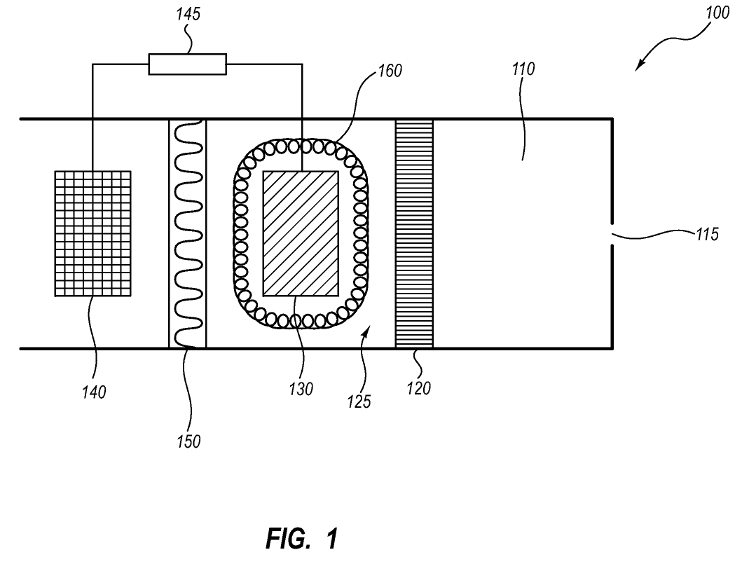

Further details of specific illustrative embodiments of the invention will now be described with reference to the accompanying drawings. FIG. 1 depicts an embodiment of anionic electrokinetic fluid deliver device 100. Fluid delivery device 100 comprises a fluid chamber 110. Fluid chamber 110 includes a port 115, through which a fluid stored in fluid chamber 110 may be delivered. It should be understood that, in some embodiments, port 115 may be in fluid communication with a catheter, tube, or other fluid delivery component. A displaceable member 120 is positioned to slide within chamber 110 so as to be capable of driving a fluid stored in chamber 110 through port 115. Displaceable member 120 in the depicted embodiment comprises a piston. However, it should be understood that a variety of other displaceable members may be used, and the term is intended to encompass any suitable structure for driving a fluid within a chamber, such as a collapsible bag, bellows, or diaphragm.

Fluid delivery device 100 also includes an electrochemical device, which is configured to provide a force against the piston 120 to force fluid out of the fluid chamber port 115. The electrochemical device in the embodiment of FIG. 1 is an ANEK system. The electrochemical device includes an active metal electrode 130 which may comprise, for example, zinc. The second electrode 140 may comprise, for example, silver chloride. Electrodes 130 and 140 are connected via circuit 145. Circuit 145 may comprise a resistor or other electrical circuit. In some embodiments, the resistor(s) may be replaceable or adjustable so as to vary the rate at which the electrochemical device operates. An ion exchange membrane 150 is positioned between the two electrodes. In the embodiment of FIG. 1, the ion exchange membrane 150 comprises an anion exchange membrane.

The following reactions occur at electrodes 130 and 140 during operation of fluid delivery 100. At electrode 140, silver chloride is reduced to metallic silver, thereby releasing chloride ions into the solution around the electrode according to the equation:
2AgCl+2e⁻→2Ag+2Cl⁻ (1)

The chloride ions subsequently formed are dissolved in water and migrate under the influence of the electric field generated by the electrochemical device through the anion exchange membrane 150 towards active metal electrode 130 adjacent piston 120. At the active metal electrode 130, zinc is dissolved according to the equation:
Zn→Zn²⁺+2e⁻ (2)

The zinc ions thus formed react with incoming chloride ions to form soluble zinc chloride according to the equation:
Zn²⁺+2Cl⁻→ZnCl₂ (3)

In addition to the electrochemical formation of zinc chloride according to equation (3), during passage of the chloride ions through the membrane 150, water is entrained with the chloride ions such that, at the opposite side of the membrane, an additional amount of water is generated. This electrokinetic water transport is known in the art as electroosmotic transport. The water molecules transported into the chamber within which active electrode 130 sits (electrochemical pump product chamber 125) generate pressure which can be used to drive piston 120 and deliver the fluid within chamber 110.

The steady buildup of ions in the electrochemical pump product chamber 125 due to the continuous formation of zinc chloride induces further water transport through an osmotic effect. An equilibrium concentration of zinc chloride is established in the electrochemical pump product chamber 125 after a period of operation resulting in water transport via the osmotic effect. A steady-state flux of water transport into the electrochemical pump product chamber 125 by combined electroosmotic and osmotic effects may thereby be established. However, osmosis may not be preferable when the fluid delivery device has to be switched on or off quickly.

Some embodiments therefore provide a method of preventing, or at least reducing, osmosis in a fluid delivery device. For example, fluid delivery device 100 includes a metal trap 160. Metal trap 160 is positioned around active metal electrode 130. Metal trap 160 may comprise, for example, a gel or mesh containing an inorganic metal chloride trapping agent—such as silver oxide or one or more organic complexing agents, such as chitosan—and is positioned and configured to reduce or eliminate the buildup of dissolvable ZnCl₂ in the pump product chamber 125. In an alternative embodiment, the metal chloride or another metal ion trapping composition may be coated on one or more of the interior walls of the pump product chamber 125.

One method for decreasing the concentration of at least one ionic or molecular species comprising a metal involves conversion of soluble ZnCl₂ to insoluble ZnO or zinc carbonate. One way to accomplish this is by reacting the ZnCl₂ with AgO or AgCO₃ coated on the inside walls of the pump product chamber 125. The following reactions will occur:
ZnCl₂+2AgO→ZnO+2AgCl (4)
ZnCl₂+2AgCO₃→ZnCO₃+2AgCl (5)

Since both ZnO and AgCl are insoluble, the ion-concentration increase in the pump product chamber will be reduced or eliminated, thereby reducing or eliminating osmosis. In other embodiments, other oxides, peroxides, superoxides, hydroxides, and/or carbonates of various elements can be used in the place of, or in addition to, AgO. Any of the foregoing materials can also, or alternatively, be present in the anode compartment in some embodiments. The materials may be, for example, provided as a free-floating powder, mixed with the anode material, or formed as a coating on the piston and/or on one or more interior walls of the anode compartment. Of course, any of the foregoing options may be available for use in the cathode compartment as well.

Other embodiments may involve complexation of ZnCl₂ to form solid precipitate. This could be accomplished by using various ZnCl₂ complexing or gelatinizing agents. One example of such an agent is carboxy methyl cellulose (CMC). Other related cellulosic materials that complex or gelatinize ZnCl₂ may also, or alternatively, be used, such as chitin or chitosan. Non-cellulosic ZnCl₂ complexing agents may include Tri-n-octyl phosphine oxide (TOPO), EDTA, Methionine, amines, diamines, phosphonates, phosphates, lactones, triflates, and/or amides. By forming a solid precipitate, the ionic activity in a particular compartment may be reduced. Any of the aforementioned materials can be made into gels by using a saline if so desired. Alternatively, other oxygen and nitrogen ligand containing materials in the form of gels or solids can be used. In the embodiment depicted in FIG. 1, the anode 130 has been enveloped with a gel 160 made from a complexing agent.

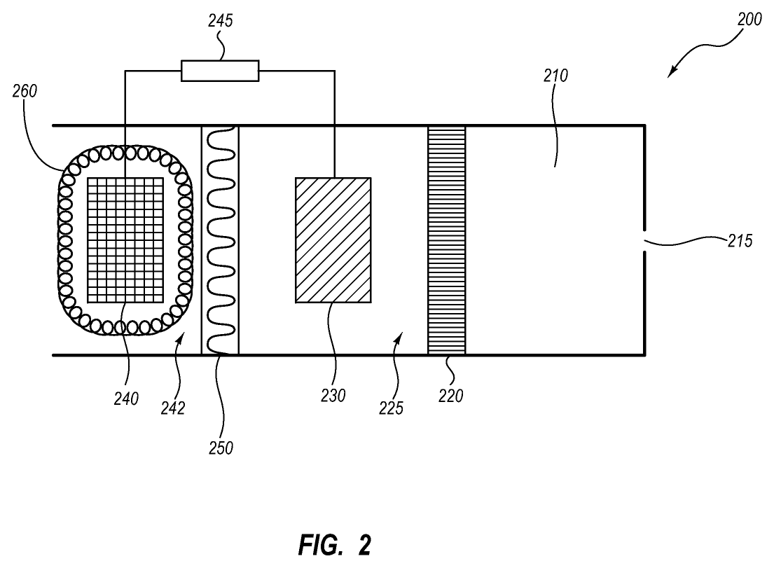

FIG. 2 depicts another embodiment of a fluid delivery device 200. Like fluid delivery device 100, fluid delivery device 200 includes a fluid chamber 210 with a port 215, a piston 220, and an active metal electrode 230 coupled to a second electrode 240 via circuit 245. An anion exchange membrane 250 is positioned between electrodes 230 and 250. However, in this embodiment, the metal trap 260 is positioned in the chamber in which electrode 240 sits. In some embodiments, electrode 240 may comprise a silver chloride electrode.

Fluid delivery device 200 may provide a method of minimizing or preventing the exposure of Zn(II) to a patient's body without eliminating the establishment of osmosis in the device. As described above, the steady buildup of ion concentration in the electrochemical pump product chamber 225 due to the continuous formation of zinc chloride induces further water transport via an osmotic effect. The ion concentration difference between the two compartments separated by the ion exchange membrane 250 creates a back-diffusion driving force for ZnCl₂ transport from the compartment associated with electrode 230 (compartment 225) to the compartment associated with electrode 240 (compartment 242) via ion exchange membrane 250. The ion exchange membrane 250 may be configured to allow for such back-diffusion of the zinc chloride molecules.

The extent of back-diffusion depends on the properties of the ion-exchange membrane and the concentration difference between the two compartments. In embodiments in which the solution surrounding electrode 240 is in fluid communication with a body fluid, as electrode 140 is exposed to the body fluid, the accumulated ZnCl₂ can potentially cause a toxicological response from the surrounding tissue, influence the encapsulation behavior, and/or facilitate unwanted protein interaction(s). It therefore may be desirable to trap the ZnCl₂ in compartment 242.

This may be accomplished in a number of ways, as described above. When AgO is used as a trapping agent, the oxide can be coated on the inside walls of compartment 242, mixed with the AgCl cathode 240, or made into a porous separator, such as a mesh, and placed between the AgCl cathode 240 and the body fluid. Alternatively, the silver oxide, or other trapping agent, may be formulated as a gel and enveloped around the cathode 240, as shown in FIG. 2.

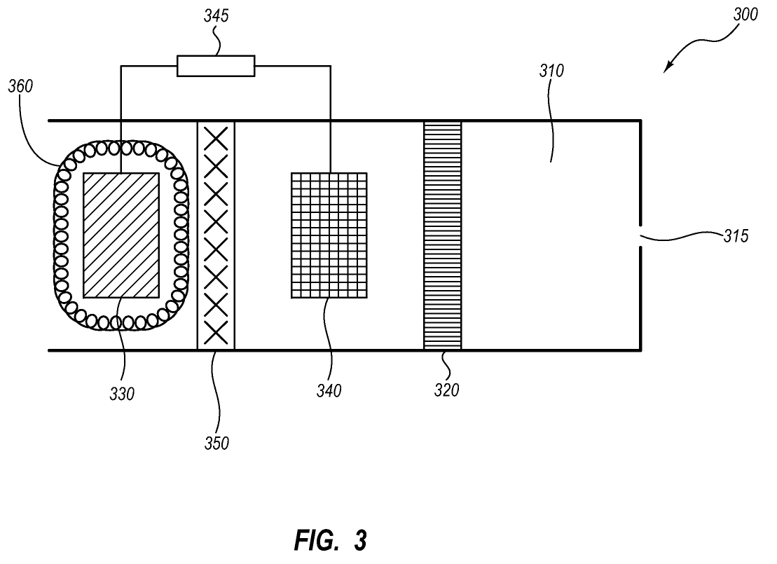

Still another embodiment of a fluid delivery device 300 is shown in FIG. 3. Like the previously-disclosed fluid delivery devices, fluid delivery device 300 includes a fluid chamber 310 with a port 315, a piston 320, and an active metal anode 330 coupled to a cathode 340 via circuit 345. An ion exchange membrane 350 is positioned between electrodes 330 and 340. However, in this embodiment, the cathode 340 is positioned adjacent to piston 320, and ion exchange membrane 350 comprises a cation exchange membrane. In addition, the metal trap 360 is positioned around the active metal anode 330, which may comprise zinc. Fluid delivery device 300 is therefore a CATEK system.

As previously mentioned, electrode 330 may comprise a Zn electrode and, in implantable embodiments, may be exposed to a body fluid. Electrode 340 may comprise an AgCl electrode. The ZnCl₂ formed can be trapped gel 360, which may contain a silver oxide, may be used to envelope the active metal electrode 330 in order to cause the ZnCl₂ to gelatinize or form a solid precipitate.

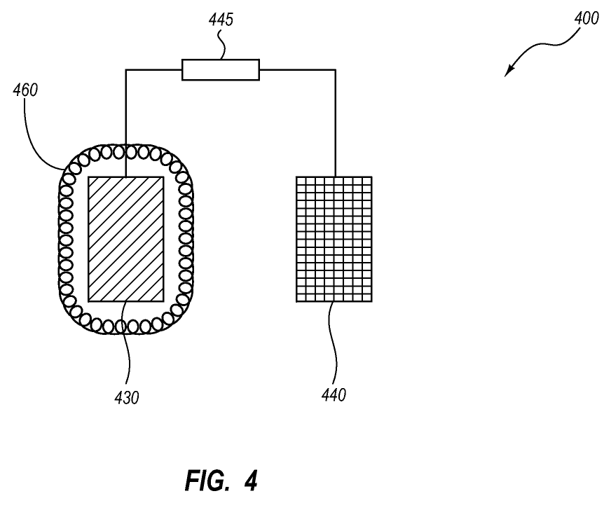

It should be understood that numerous variations are possible that may be employed without departing from the spirit and scope of the invention. For example, the general principles disclosed herein may be pertinent to applications other than fluid delivery devices. To illustrate one such application. FIG. 4 depicts a power source 400. Power source 400 comprises an anode 430 coupled to a cathode 440 via circuit 445. In some embodiments, anode 430 may comprise a metal or metal salt anode. As in fluid delivery devices, it may be desirable in power sources to decrease the concentration of at least one ionic or molecular species comprising a metal in an adjacent solution. In order to achieve this decrease in concentration, power source 400 includes a metal trap 460. Metal trap 460 is shown as comprising a gel positioned around the active metal electrode 430, although any of the other metal trap compositions and methods described above may alternatively be used. It should be understood that the power source components depicted in FIG. 4 would ordinarily be incorporated into some sort of a housing, even though such a housing is not shown in the figure.

Of course, although several particular chemical compositions and material have been disclosed herein, it should be understood that numerous variations thereof are possible a well. For example, although the active metal electrode has been disclosed as comprising zinc, other metals or metal salts may be used, such as magnesium, aluminum, iron, manganese chloride, and/or platinum chloride. In addition, although the cathode has been disclosed as comprising silver chloride, other materials may be used, such as silver oxide, copper chloride, oxygen reduction cathodes, and/or hydrogen-generation cathodes.

In addition, each of the fluid chambers disclosed and described herein can be considered means for storing a fluid. Likewise, each of the pistons and other displaceable members disclosed herein, along with the ports in their respective fluid chambers, can be considered means for steadily releasing a fluid from a storing means. Finally, several examples of means for decreasing the concentration of at least one ionic or molecular species comprising a metal, the ionic or molecular species having been generated by the electrochemical device in a solution, have been disclosed herein. To illustrate, a coating on an interior wall of a fluid delivery device (or on a displaceable member of a fluid delivery device) or power source is one example of a means for decreasing the concentration of at least one ionic or molecular species comprising a metal. A more specific example of such a coating would be a silver oxide coating. Another example of a means for decreasing the concentration of at least one ionic or molecular species comprising a metal is a gel positioned proximate—such as enveloping—at least one of the electrodes in an electrochemical device. Still another example of a means for decreasing the concentration of at least one ionic or molecular species comprising a metal is a porous separator or mesh, which may be positioned between a body fluid and an electrode in a fluid delivery device. Yet another example of a means for decreasing the concentration of at least one ionic or molecular species comprising a metal is a free-floating powder positioned proximate at least one of the electrodes in an electrochemical device.

The above description fully discloses the invention including preferred embodiments thereof. Without further elaboration, it is believed that one skilled in the art can use the preceding description to utilize the invention to its fullest extent. Therefore the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

1. An electrochemical device, comprising:
a first electrode;
a second electrode coupled to the first electrode; and
a metal trap configured to decrease the concentration of at least one ionic or molecular species comprising a metal, the ionic or molecular species having been generated by the electrochemical device in a solution proximate at least one of he electrodes.

2. The electrochemical device of claim 1, wherein the metal trap comprises a metal ion trap that is configured to decrease the concentration of soluble metal ions in the solution.

3. The electrochemical device of claim 2, wherein the metal ion trap is configured to decrease the concentration of metal chloride ions in the solution.

4. The electrochemical device of claim 1, wherein the metal trap comprises a coating on an interior wall of the electrochemical device.

5. The electrochemical device of claim 4, wherein the coating comprises silver oxide.

6. The electrochemical device of claim 1, wherein the metal trap functions by chemically converting soluble metal ions into insoluble matter.

7. The electrochemical device of claim 1, wherein the metal trap functions by gelatinizing the at least one ionic or molecular species comprising a metal.

8. The electrochemical device of claim 1, wherein the metal trap comprises a gel positioned proximate at least one of the electrodes.

9. The electrochemical device of claim 1, wherein the electrochemical device comprises a power source.

10. The electrochemical device of claim 1, further comprising an ion exchange membrane positioned between the first and second electrodes.

11. The electrochemical device of claim 10, wherein the ion exchange membrane comprises an anion exchange membrane.

12. The electrochemical device of claim 10, wherein the electrochemical device comprises a fluid delivery device.

13. The electrochemical device of claim 12, wherein the electrochemical device comprises an implantable fluid delivery device.

14. The electrochemical device of claim 1, further comprising a resistor coupled between the first electrode and the second electrode.

15. An electrochemical fluid delivery device, comprising:
a fluid chamber comprising a port;
a displaceable member at least partially defining the fluid chamber;
an electrochemical device configured to provide a force against the displaceable member to force fluid out of the fluid chamber port; and
a metal trap configured to decrease the concentration of at least one ionic or molecular species comprising a metal, the ionic or molecular species having been generated by the electrochemical device in a solution proximate the electrochemical device.

16. The electrochemical fluid delivery device of claim 15, wherein the metal trap comprises a metal ion trap that is configured to decrease the concentration of soluble metal ions in the solution.

17. The electrochemical fluid delivery device of claim 15, wherein the metal trap comprises a coating on an interior wall of the electrochemical device.

18. The electrochemical fluid delivery device of claim 16, wherein the coating comprises silver oxide.

19. The electrochemical fluid delivery device of claim 15, wherein the metal trap functions by chemically converting soluble metal ions into insoluble matter.

20. The electrochemical fluid delivery device of claim 15, wherein the metal trap functions by gelatinizing the at least one ionic or molecular species comprising a metal.

21. The electrochemical fluid delivery device of claim 15, wherein the metal trap comprises a gel.

22. The electrochemical fluid delivery device of claim 15, wherein the electrochemical device comprises:
a first electrode;
a second electrode coupled to the first electrode and positioned adjacent to the displaceable member; and
an ion exchange membrane positioned between the first and second electrodes.

23. The electrochemical fluid delivery of claim 22, further comprising a resistor coupled between the first electrode and the second electrode.

24. The electrochemical fluid delivery of claim 22, wherein the ion exchange membrane comprises a cation exchange membrane.

25. The electrochemical fluid delivery of claim 15, wherein the fluid delivery device is configured to be implanted in a human body.

26. The electrochemical fluid delivery device of claim 15, wherein the displaceable member comprises a piston.

27. An electrochemical fluid delivery device, comprising:
means for storing a fluid;
means for steadily releasing the fluid from the storing means; and
means for decreasing the concentration of at least one ionic or molecular species comprising a metal, the ionic or molecular species having been generated by the electrochemical device in a solution.

28. The electrochemical fluid delivery device of claim 27, wherein the means for decreasing the concentration of at least one ionic or molecular species comprising a metal comprises a means for decreasing the concentration of soluble metal ions generated by the electrochemical device in the solution.

29. The electrochemical fluid delivery device of claim 28, wherein the means for decreasing the concentration of soluble metal ions comprises a coating on an interior wall of the electrochemical fluid delivery device.

30. The electrochemical fluid delivery device of claim 29, wherein the coating comprises a silver oxide coating.

31. The electrochemical fluid delivery device of claim 28, wherein the means for decreasing the concentration of soluble metal ions functions by chemically converting soluble metal ions into insoluble matter.

32. The electrochemical fluid delivery device of claim 28, wherein the means for decreasing the concentration of soluble metal ions functions by gelatinizing metal ions.

33. The electrochemical fluid delivery device of claim 27, wherein the means for steadily releasing the fluid from the storing means comprises a piston.

34. The electrochemical fluid delivery device of claim 33, wherein the means for steadily releasing the fluid from the storing means further comprises an electrochemical device configured to provide a force against the piston.

35. An electrochemical fluid delivery device comprising:
a fluid chamber;
a post in fluid communication with the fluid chamber and positioned to direct fluid out of the fluid chamber;
a piston slidably positioned in the fluid chamber:
an electro-osmotic engine comprising:
an active metal electrode;
a metal chloride electrode coupled to the active metal electrode; and
an ion exchange membrane positioned in a solution between the active metal electrode and the metal chloride electrode; and
a metal ion trap configured to decrease the concentration of soluble metal ions generated by the electro-osmotic engine in the solution.
